(19) United States
(12) Patent Application Publication
(10) Pub. No.: US 2010/0167690 A1
(43) Pub. Date: Jul. 1, 2010

(54) user terminal for enhanced security in a wireless communications system, and a system for its use

(76) Inventors: Mats Andersson, Goteborg (SE); Bo Göransson, Sollentuna (SE)

Correspondence Address: ERICSSON INC., 6300 LEGACY DRIVE, M/S EVR 1-C-11, PLANO, TX, 75024, US

(21) Appl. No.: 12/305,827

(22) PCT Filed: Jun. 20, 2006
(86) PCT No.: PCT/SE2006/000744

§ 371 Date: Dec. 19, 2008

(51) Int. Cl. H04W 12/00; H04K 1/00

(52) U.S. Cl. 455/410; 380/270

(57) ABSTRACT

The invention discloses a user terminal (100) for use in a wireless communications system for voice calls and/or data sessions, which is equipped with means (140) for receiving and transmitting encrypted voice and/or data traffic to and from a second terminal in the system via a first node in the system. The user terminal is equipped with means (130) for splitting outgoing encrypted traffic during one and the same voice conversation and/or one and the same data session, so that a first part of the encrypted traffic to said second terminal is sent via said first node, and a second part is sent via a second node in the system.

### TECHNICAL FIELD

The present invention discloses a user terminal for use in a wireless communications system for voice calls and/or data sessions. The user terminal is equipped with means for receiving and transmitting encrypted voice and/or data traffic to and from a second terminal in the system via a first node in the system.

The invention also discloses a wireless communications system and a method which employs the same principles as the user terminal of the invention.

### BACKGROUND ART

Secure communications in wireless communications systems such as, for example, mobile telephony systems, has attracted a great amount of interest lately.

The traditional method of achieving secure communications in wireless or other systems has been to encrypt the traffic. Due to recent advances in cryptology, a high degree of communications security can be achieved using this method. However, unbreakable or nearly unbreakable encryption still carries very high costs with it, if it can be achieved at all. Also, the demands for processor power in such systems is very high, both on the transmit and on the receive side.

### DISCLOSURE OF THE INVENTION

As shown above, there is a need for a method and a system which could provide a high degree of communications security in a wireless communications system at a reasonable cost, and without excessive demands on processor power.

Such a method is provided by the present invention, in that it discloses a user terminal for use in a wireless communications system for voice calls and/or data sessions, the user terminal being equipped with means for receiving and transmitting encrypted voice and/or data traffic to and from a second terminal in the system via a first node in the system.

The user terminal is equipped with means for splitting encrypted traffic during one and the same voice conversation and/or one and the same data session, so that a first part of the encrypted traffic to said second terminal is sent via said first node, and a second part is sent via a second node in the system.

In one embodiment, the user terminal is additionally equipped with means for receiving split encrypted traffic from said second terminal in the system via at least two different nodes in the system, and for this purpose the user terminal is equipped with means for “de-splitting” the received traffic from said two nodes. Suitably, but not necessarily, said two nodes from which traffic is received are the same as those nodes to which traffic is sent from the user terminal.

Thus, a user terminal according to the invention can “spread” one and the same phone call or data session over a multitude of nodes, or in the case of cellular telephony, a multitude of base stations. Not only is the traffic encrypted, so that intercepted traffic will be difficult to understand, a possible eavesdropper will also have to intercept traffic to and from more than one base station (“node”), which is much more difficult than intercepting traffic to and from one base station.

The splitting or spreading of traffic to and from the user terminal can be done in a variety of ways, or in a combination of ways. Some such ways which can be mentioned are the use of different time slots, multiple transmit beams in an antenna of the user terminal, multiple polarizations in at least one antenna beam in an antenna of the user terminal, multiple frequency slots or multiple codes, or one or more steerable antenna beams

The invention also discloses a system and method which utilize the same fundamental principles as the user terminal of the invention.

### BRIEF DESCRIPTION OF THE DRAWINGS

The invention will be described in more detail below, with reference to the appended drawings, in which

FIG. 1 shows a schematic block diagram of a user terminal according to the invention, and

FIG. 2 shows a system in which a terminal of the invention is employed, and

FIG. 3 shows a basic flow chart of the function of a user terminal according to the invention.

### EMBODIMENTS OF THE INVENTION

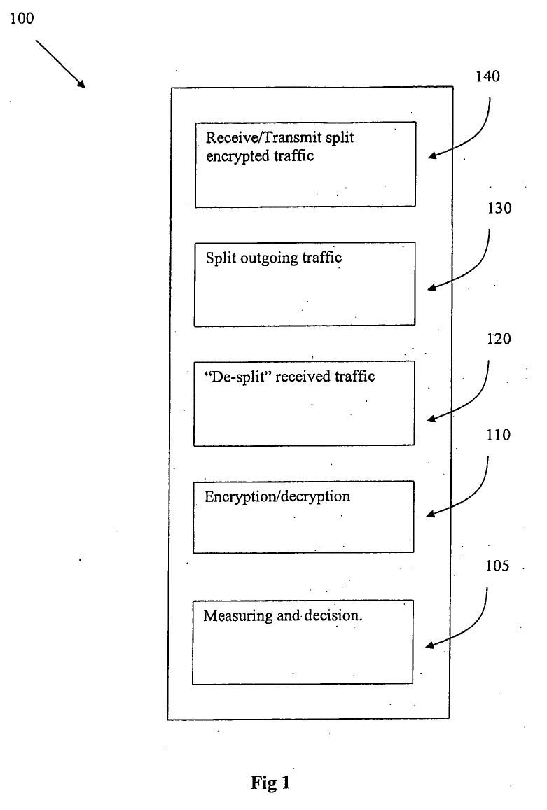

FIG. 1 shows a basic block diagram of some functional components of a user terminal 100 of the invention. The components shown are means 110 for encrypting and decrypting outgoing and incoming traffic respectively, as well as means 130 for splitting outgoing traffic and means 120 for “de-splitting” received traffic. The user terminal 100 also comprises means 140 for receiving and transmitting split encrypted traffic.

All of the above components of the user terminal 100 and their functions will be described in more detail below.

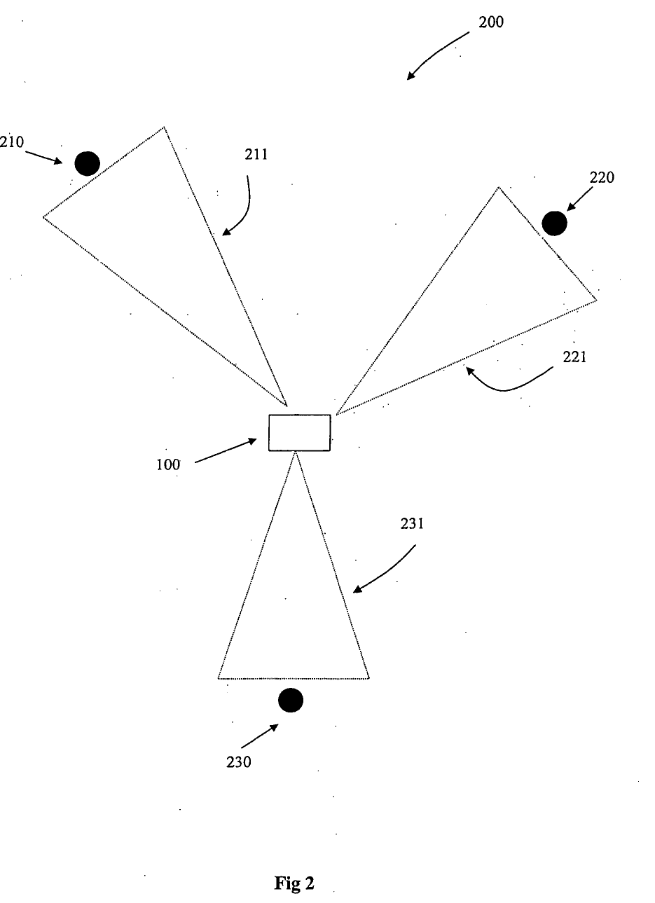

FIG. 2 shows a schematic overview of a system 200 in which a user terminal 100 of the invention is employed. The system and the user terminal will be exemplified by means of a user terminal in a system for cellular telephony, but other kinds of user terminals and systems can also employ the invention. Examples of other kind of user terminals are portable computers with cellular capabilities, or units with wireless LAN possibilities in a LAN.

The user terminal 100 can be used for voice calls and/or data sessions with other users (not shown) in the system 200. In order to enhance the communications security, the user terminal 100 is equipped with means for encrypting said voice and/or data traffic to and from other users (terminals) in the system, as well as means for decrypting received voice and/or data traffic from other users.

The encryption and corresponding decryption means can be of a wide variety of kinds, and can be either in hardware or software or a combination of those. Encryption algorithms or principles which are well known to those skilled in the art can be used with the invention, for which reason those principles will not be elaborated upon here.

In traditional cellular telephony, a user terminal communicates with other users in the system via a radio base station (RBS). There is a plurality of base stations in the system, and all traffic to and from one and the same terminal is routed via one RBS, usually the one with the best signal quality at the time. Thus, a user terminal will usually be listening to traffic not only from the base station through which its traffic is routed, it will also monitor signals from other base stations within range, in order to measure signal quality for use in deciding when the traffic should be routed through another base station than the one currently used, a so called “hand-over”. This situation is exemplified in FIG. 2 where there is one user terminal 100, in the vicinity of which there are three base stations, 210, 220, 230, with respective coverage areas, 211, 221, 231.

The user terminal 100 of the invention makes use of the principle mentioned above, i.e. that there is, at least in most environments, more than one RBS with signal strengths such that the terminal 100 could route its traffic via them. In the example of FIG. 2, it is assumed that the signal quality is sufficient for this for all three of the base stations shown in the system 200.

According to the invention, the user terminal 100 is equipped with means 130 for splitting outgoing encrypted traffic during one and the same voice call or data session between two or more base stations, so that, in the case where two base stations are used, a first part of the encrypted traffic to another user is sent via a first base station, and a second part is sent via a second base station in the system.

In a corresponding manner, the user terminal 100 of the invention is also equipped with means 120 for “de-splitting” the received traffic from said first and second nodes

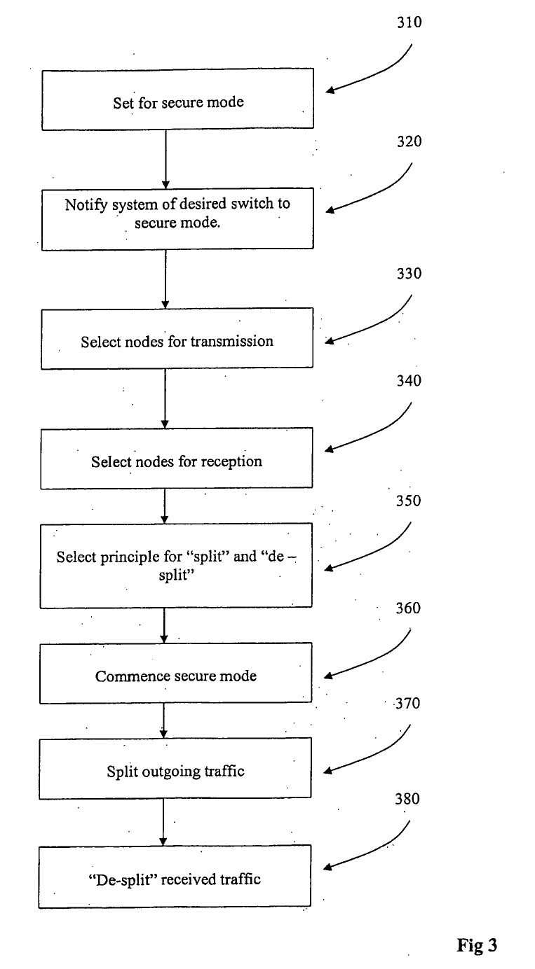

Some possible methods for use when splitting will be described below, but a possible scenario for use of the invention is as follows, with reference to the flow chart shown in FIG. 3. It should be pointed out that the steps shown in FIG. 3 and described below do not need to be carried out in the order shown in FIG. 3, the same result may be achieved with the steps taken in a different order.

A user sets his terminal 100 to work in the “secure mode” of the invention, block 310 of the flow chart, or, alternatively, this is the only mode in which the terminal can operate, in which case the step of block 310 corresponds to activation of the terminal. As a third alternative, the terminal can be notified by the system, via at least one base station, that the system wants the terminal to use the secure mode.

Block 320 is used if the decision to use secure mode is taken at or by the user terminal: the user terminal notifies the system, via at least one base station of the decision to use the secure mode.

In blocks 330 and 340, decisions are made regarding which nodes or base stations that should be used in receiving traffic from (330) and sending traffic to (340) the user terminal. It should be pointed out that if there is a sufficient amount of base stations with a sufficient signal strength in the area, the same base stations need not be used for receiving traffic from the user terminal as are used for sending traffic to the user terminal.

Thus, outgoing traffic from the terminal can be split between a first and a second base station, and traffic can be received at the user terminal from two different base stations, where said first and second base stations are not the same as said two different base stations.

The decisions in blocks 330 and 340 are preferably made at “system level”, i.e. the system comprises a function which is able to coordinate the actions of the base stations and which takes the decisions regarding which base stations to use. These decisions can preferably be based on parameters such as the signal levels received at the user terminal from the base stations, and the signal levels received at the base stations from the terminal, as well as the load at each individual base station.

The signal levels measured at the user terminal from the base stations, and at the base stations from the user terminal are parameters which are already measured today, in order to decide and prepare for hand over of user terminals between different base stations.

As an alternative to having the decision on which base stations to use taken at system level, the decision can be taken at one of the base stations which would then have a special function for this, using the parameters mentioned above, which could be received via the system from other base stations and from the terminal, or from the terminal alone, in which case the terminal could pass on information from one base station to another.

It is also conceivable to have said decision taken at the user terminal, based on the criteria mentioned above. The decision would then be communicated by the user terminal to the base stations involved.

Also, if there is a large number of nodes detected in blocks 330 and 340 which meet the criteria for use, the decision can be to select only a sub-set of those nodes to be used for transmitting or receiving encrypted traffic to and from the user terminal respectively. Otherwise, what happens in the step of blocks 330 and 340 is that all of the available nodes are selected for use.

In block 350, a decision is made regarding the principle that is to be used for splitting the traffic from the user terminal to the base stations, and from the base stations to the terminal. Suitably, the same principle is used in both directions, although this need not be the case.

The user terminal is pre-programmed with the possibility of using a number of different principles for splitting outgoing traffic, and for de-splitting received or incoming traffic. The same principles can, if necessary, be programmed into the base stations of the system.

Although the same effect can conceivably be obtained with other principles, some examples of principles for split and “de-split” of the traffic to and from the user terminal, respectively, which are envisioned at present are:
The use of different time slots. In other words, if, for example, two base stations are used for receiving the traffic from the user terminal, the user terminal will transit to the first base station in a first time slot or set of slots, and to the second base station in a second time slot or set of slots, and will repeat this. Similarly, if this principle is used for reception at the terminal, it will be used for transmission by the base stations to the terminal, so that the first terminal will transmit to the user terminal in a first time slot or set of slots, and the second base station in a second time slot or set of slots.
The use of different transmit beams in an antenna of the user terminal. According to this principle, the user terminal has an antenna that can generate multiple transmit beams, which is used so that a first beam directed towards a first node and a second beam towards a second node. Preferably, each beam covers only its respective node. Alternatively, if different base stations are used to transmit and receive to and form the user terminal, these different base stations can be covered by different antenna beams.
The use of different polarizations in at least one antenna beam in an antenna of the user terminal. In other words, if one and the same antenna beam of the user terminal is used to cover, for example, two base stations, communication with one of the base stations can be in a first polarization, and with the other base station in a second polarization, the polarizations preferably being orthogonal to each other, for example horizontal and vertical polarization.
The use of different frequency slots. This is similar to the use of different time slots, but instead, different frequencies are used, so that if, for example, two base stations are used for receiving the traffic from the user terminal, the user terminal will transit to the first base station on a first frequency or set of frequencies, and to the second base station on a second frequency or set of frequencies. Similarly, if this principle is used for reception at the terminal, it will be used for transmission by the base stations to the terminal, so that the first terminal will transmit to the user terminal on a first frequency or set of frequencies, and the second base station on a second frequency or set of frequencies.
The use of different multiplexing codes. According to this principle, as used for example in the CDMA system (Code Division Multiple Access) communication between the user terminal and a first and a second base station is carried out by means of a first and a second set of multiplexing codes, respectively. The communication can thus, in principle, be on one and the same frequency to and from more than one base station.

It should be pointed out that the principle used for splitting traffic from the user terminal to the base station does not need to be the same as that used for splitting the traffic that is sent from the base stations to the user terminal, but in a preferred embodiment the same principle is used for traffic in both directions.

When the nodes to be used for communicating with the user terminal have been selected, blocks 330 and 340, and the principle/principles for use in splitting the traffic to/from the user terminal are chosen, block 350, the communication in “secure mode” can commence, block 360. As mentioned previously, the enhanced security in this mode is obtained by use of encryption as well as by means of the use of more than one node for receiving traffic from the user terminal and for sending traffic to the user terminal during one and the same voice call or data session, or conceivably a call that involves the transfer of both voice and data.

Thus, somebody wishing to eavesdrop on a user terminal according to the invention would need to intercept traffic between the user terminal and at least two base stations, and would then need to “de-split” the traffic according to the principle used by the system, in addition to breaking the encryption method used.

When the secure mode commences, block 360, this entails, as outlined above, splitting outgoing decrypted traffic at the user terminal, block 370, and “de-splitting” incoming decrypted traffic at the user terminal, block 380. Naturally, there are two alternatives here: either the traffic can first be split and the encrypted, or first encrypted and then split, and similarly for incoming traffic. However, in a preferred embodiment, outgoing traffic is first split and then encrypted, in order to enable the use of different encryption for different “traffic splits”, and incoming traffic is first decrypted and then “de-split”. However, the reverse order is of course also possible.

The invention is not limited to the examples of embodiments shown above, but may be varied freely within the scope of the appended claims. As an example of such a variation, it would be perfectly possible to switch split principle during an ongoing voice or data session, or to combine principles during one and the same session, provided that the standard of the system used permits this. For example, the GSM system would at present not permit a combination of time slot split and multiplex code split, but future systems such as, for example, systems beyond the 3G systems or WiMax might permit such combining.

Also, the number of RBS:s used by one and the same user terminal during one and the same session might be changed during an ongoing session.

In another embodiment of the invention, only one of the terminals involved in a communication use the principle of splitting and de-splitting traffic. In such an embodiment, the first terminal would send split traffic via a number of nodes, and the system as such would comprise means for de-splitting the traffic before it is sent to the second terminal. Thus, the enhanced security would be offered at one end of the communication, but not at the other end.

The principle of letting the system de-split the traffic can also be used even if both of the user terminals utilize the invention: in such a system, the traffic would be de-split by the system after being received form the first user terminal, and would then be split again before being sent to the second user terminal. Thus, four main cases can be discerned:
Only one of the first and second user terminals splits outgoing encrypted traffic. The split traffic is de-split by the system.
Both of the first and second user terminals split outgoing encrypted traffic. The split traffic is de-split by the system.
Both of the first and second user terminals split outgoing encrypted traffic, and one of them can de-split received traffic. For the other terminal, the split traffic is de-split by the system.
Both of the first and second user terminals split outgoing encrypted traffic, and they can both de-split the received traffic.

It should also be noted that in those cases where the traffic is de-split by the system, this can take place at a more or less arbitrarily chosen node in the system, in other words the traffic does not need to be de-split at “RBS level”.

1. A user terminal (100) for use in a wireless communications system for voice calls and/or data sessions, said user terminal (100) being equipped with means (140) for receiving and transmitting encrypted voice and/or data traffic to and from a second terminal in the system via a first node in the system, the user terminal being characterized in that it is equipped with means (130) for splitting outgoing encrypted traffic during one and the same voice conversation and/or one and the same data session so that a first part of the encrypted traffic to said second terminal is sent via said first node, and a second part is sent via a second node in the system.

2. The user terminal of claim 1, additionally being characterized in that it is equipped with means (140) for receiving split encrypted traffic from said second terminal in the system via at least two different nodes in the system, the user terminal (100) also being equipped with means (120) for “de-splitting” the received traffic from said at least two different nodes.

3. The user terminal (100) of claim 1, in which the means (130) for splitting traffic to the second user is based on the use of different time slots.

4. The user terminal (100) of claim 1, in which the means (130) for splitting traffic to the second user is based on the use of different transmit beams in an antenna of the user terminal (100).

5. The user terminal (100) of claim 1, in which the means (130) for splitting traffic to the second user is based on the use of a steerable antenna beam, which is steered to the node which is used at each moment.

6. The user terminal (100) of claim 1, in which the means (130) for splitting traffic to the second user is based on the use of different polarizations in at least one antenna beam in an antenna of the user terminal.

7. The user terminal (100) of claim 1, in which the means (130) for splitting traffic to the second user is based on the use of different frequency slots.

8. The user terminal (100) of claim 1, in which the means (130) for splitting traffic to the second user is based on the use of different multiplexing codes.

9. The user terminal (100) of claim 1, in which the means for splitting traffic to the second user is based on a combination of at least two of the following principles:
the use of different time slots.
the use of different transmit beams in an antenna of the user terminal (100).
the use of a steerable antenna beam, which is steered to the node which is used at each moment.
the use of different polarizations in at least one antenna beam in an antenna of the user terminal.
the use of different frequency slots.
the use of different multiplexing codes.

10. The user terminal (100) of any of claims 2-8, in which the means (120) for “de-splitting” the received traffic is based on the same principle as the one used for transmitted traffic.

11. The user terminal (100) of any of claims 2-8, in which the means (120) for “de-splitting” the received traffic is one of the following:
the use of different time slots.
the use of different transmit beams in an antenna of the user terminal (100).
the use of a steerable antenna beam, which is steered to the node which is used at each moment.
the use of different polarizations in at least one antenna beam in an antenna of the user terminal.
the use of different frequency slots.
the use of different multiplexing codes.

12. A method for achieving enhanced communication security in a wireless communications system (200) for voice calls and/or data sessions, in which system (200) encrypted voice and/or data traffic is exchanged between at least a first (100) and a second user terminal via at least a first node (210, 220, 230) in the system, the method being characterized in that it comprises letting said first (100) and second user terminals split outgoing encrypted traffic during one and the same voice conversation and/or one and the same data session, so that a first part of the outgoing encrypted traffic from each of said terminals is sent via said first node, and a second part is sent via a second node in the system.

13. The method of claim 12, additionally comprising letting said first (100) and second user terminals receive said first and second parts of the encrypted traffic from the other terminal via said first and second nodes, and letting said user terminals “de-split” the received traffic.

14. The method of claim 13, according to which the first (100) and second user terminals split the outgoing encrypted traffic by using different time slots.

15. The method of claim 12, according to which the first (100) and second user terminals split the outgoing encrypted traffic by using different transmit beams in an antenna of the user terminal.

16. The method of claim 15, according to which the different antenna beams are employed to direct a first beam to the first node and a second beam to the second node.

17. The method of claim 12, according to which the first (100) and second user terminals split the outgoing encrypted traffic by using different polarizations in at least one antenna beam in an antenna of the user terminal (100).

18. The method of claim 12, according to which the first (100) and second user terminals split the outgoing encrypted traffic by using by using different frequency slots

19. The method of claim 12, according to which the first (100) and second user terminals split the outgoing encrypted traffic by using by using different multiplexing codes.

20. The method of claim 13, according to which the first and second user terminals (100) “de-split” the received traffic, based on the same principle as the one used for splitting transmitted traffic.

21. The method of claim 13, in which the principle for “de-splitting” the received traffic is one of the following:
the use of different time slots.
the use of different transmit beams in an antenna of the user terminal (100).
the use of a steerable antenna beam, which is steered to the node which is used at each moment.
the use of different polarizations in at least one antenna beam in an antenna of the user terminal.
the use of different frequency slots.
the use of different multiplexing codes.

22. A wireless communications system (200) for voice calls and/or data sessions, the system comprising at least a first (210, 220, 230) and a second (210, 220, 230) node for sending encrypted voice and data traffic to and receiving encrypted voice and data traffic from user terminals (100) in a geographical area covered by the system, the system in addition also comprising functionalities for:
Receiving signals from a first user terminal (100) or sending signals to the first user terminal (100) that the terminal should or desires to commence sending and/or receiving traffic in a secure mode, the secure mode being a mode where traffic for one and the same voice call or data session is received from the first user terminal (100) by at least a first and a second node, the traffic being split between said nodes,
Processing said split traffic before it is sent to a second, receiving user terminal in the system.

23. The system of claim 22, in which said functionality for processing the split traffic comprises a functionality for de-splitting the traffic.

24. The system of claim 22, in which said functionality for processing the split traffic comprises a functionality for forwarding the split traffic to the second user terminal.

25. The system of any of claims 22-24, further comprising functionalities for receiving split traffic form the second user terminal via at least two different nodes.

26. The system (200) of any of claims 21-25 additionally being equipped with a functionality for deciding which principle should be used for the splitting of the traffic, said principle being chosen from a plurality of predefined such principles.

27. The system (200) of claim 26, in which the principle for splitting the traffic is chosen from among the following:
the use of different time slots,
the use of different transmit beams in an antenna of the user terminal,
the use of a steerable antenna beam, which is steered to the node which is used at each moment,
the use of different polarizations in at least one antenna beam in an antenna of the user terminal,
the use of different frequency slots,
the use of different multiplexing codes.

28. The system (200) of claim 27, in which the principle for de-splitting the traffic is chosen from among the following:
the use of different time slots,
the use of different transmit beams in an antenna of the user terminal,
the use of a steerable antenna beam, which is steered to the node which is used at each moment,
the use of different polarizations in at least one antenna beam in an antenna of the user terminal,
the use of different frequency slots,
the use of different multiplexing codes.
